(19) United States
(12) Patent Application Publication
(10) Pub. No.: US 2012/0270977 A1
(43) Pub. Date: Oct. 25, 2012

(54) TITANIUM DIOXIDE DISPERSION LIQUID, METHOD FOR MANUFACTURING TITANIUM DIOXIDE DISPERSION LIQUID, AND ORGANIC OPTICAL ELEMENT

(75) Inventors: Katsumoto Hosokawa, Tokyo (JP); Terunobu Saitoh, Kawasaki-shi (JP); Kikuo Okuyama, Higashihiroshima-shi (JP)

(73) Assignee: CANON KABUSHIKI KAISHA, Tokyo (JP)

(21) Appl. No.: 13/430,940

(22) Filed: Mar. 27, 2012

(30) Foreign Application Priority Data
Mar. 31, 2011 (JP) 2011-079564

(51) Int. Cl. C08L 83/00; C08K 5/5419; B82Y 30/00

(52) U.S. Cl. 524/266; 106/447; 524/265; 977/773

(57) ABSTRACT

A titanium dioxide dispersion liquid in which the transmittance is 80% or more is manufactured by dispersing titanium dioxide fine particles having an average primary particle diameter of 1 nm or more and 30 nm or lower in a solution containing diglyme which is a solvent and trimethoxypropylsilane which is a dispersant. By doping titanium dioxide fine particles with nitrogen atoms, and then dispersing the same by an atomization device using beads having an average particle diameter of 15 μm or more and 30 μm or lower, a titanium dioxide dispersion liquid capable of maintaining transparency stability over a long period of time is manufactured.

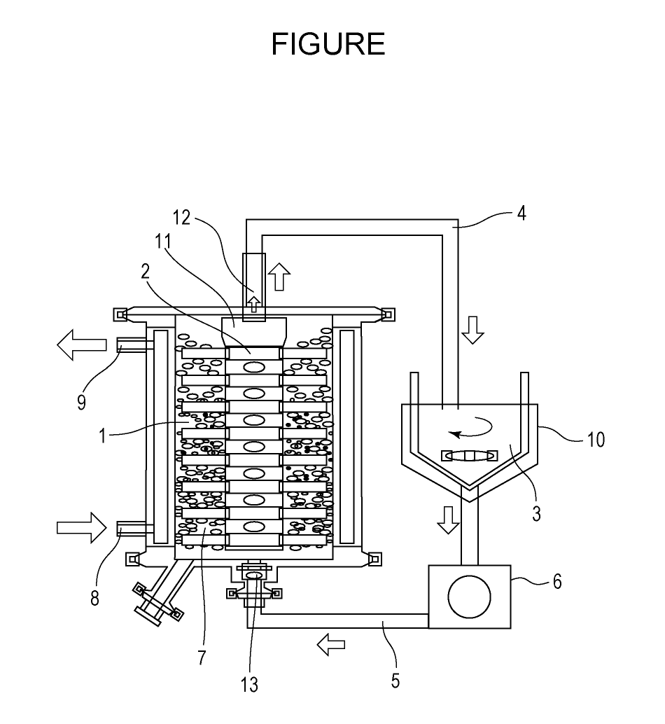

### BACKGROUND OF THE INVENTION

1. Field of the Invention

The present invention relates to a titanium dioxide containing resin composition for use in optical elements, such as a refractive optical element, a diffractive optical element, a lens, a prism, a filter, and an antireflection film, a titanium dioxide dispersion liquid for use in the same, and a method for manufacturing the same.

2. Description of the Related Art

Heretofore, in refractive optical elements, diffractive optical elements, and the like containing glass or an organic resin, various aberrations have been reduced by combining optical materials different in the refractive index or the wavelength dispersion thereof and the secondary dispersion.

In general, an optical organic resin has excellent processability as compared with optical glass. Therefore, the optical organic resin can be easily processed in a short time by molding at a relatively low temperature by injection molding, cast molding, or the like, by molding by radiation (ultraviolet rays) curing, or the like. In contrast, since the optical glass is processed by molding at a relatively high temperature or by crushing or polishing, the processing cost inevitably becomes higher than that of the optical organic resin.

However, a known optical organic resin has had a limitation in the range of characteristics of a refractive index or a wavelength dispersion and a secondary dispersion as compared with the optical glass. Therefore, when the configuration or the number of lenses has a limitation depending on the performance, the usage manner, or the like of products, it becomes difficult to sufficiently correct a chromatic aberration and the like, and thus the utilization range thereof is limited.

In recent years, an organic-inorganic composite material in which inorganic fine particles atomized into a nano size are uniformly dispersed in an organic resin has drawn attention. When the material is used in optical elements, optical characteristics can be imparted to the inorganic particles, which cannot be achieved by an organic substance alone, while maintaining the ease of processing of the organic resin. However, since substances having different optical characteristics are used, light is scattered. Therefore, it is necessary to atomize the particle size of inorganic fine particles to about 1/10 of the wavelength of the light to be used.

For example, titanium dioxide which is one of inorganic substances is known to have a high refractive index, and the use thereof as an optical element material having a high refractive index has been variously examined. In general, in the use in which the light scattering ratio needs to be low in a wavelength region of visible light, it is considered that the maximum length of titanium dioxide, fine particles is suitably 50 nm or lower and more suitably 30 nm or lower. However, titanium dioxide fine particles with a primary particle diameter of 50 nm or lower are likely to aggregate due to the size of the surface area. It is difficult in many cases to disperse fine particles, which are aggregated once, into primary particles again with high uniformity.

Japanese Patent Laid-Open No. 8-193172 discloses a manufacturing method including atomizing inorganic particles by causing a medium and inorganic particles to collide in an atomizing chamber containing at least the medium, the inorganic particles, and a dispersion medium, and dispersing the inorganic particles in the dispersion medium. In more detail, the manufacturing method includes atomizing a pigment, a dye, and the like by a medium having a medium diameter of 0.1 to 0.3 mm, and separating the particles whose particle size is equal to or lower than a target particle size with a filter bed.

However, it is considered that, in the treatment using a medium having a medium diameter of 0.1 to 0.3 mm disclosed in Japanese Patent Laid-Open No. 8-193172, the kinetic energy transmitted from the medium to the inorganic particles becomes higher as the inorganic particles are crushed and the exposed area of the fractured surface of the inorganic particles becomes larger. The newly exposed fractured surface having high polarity or activity easily develops an interaction between inorganic particles and/or between inorganic particles and liquid molecules. This causes re-aggregation of fine particles or an increase in viscosity of an inorganic particle mixture. Therefore, the dispersion of titanium dioxide particles having a particle diameter of 50 nm or lower which are likely to aggregate is very difficult.

The present inventors have further advanced examination and have examined atomizing titanium dioxide particles having a particle diameter of 50 nm or lower by optimizing the diameter or the like of a medium. When the titanium dioxide fine particles are atomized to be primarily dispersed, clouding of a titanium dioxide dispersion liquid is gradually reduced.

However, it is confirmed that the titanium dioxide dispersion liquid becomes yellow as the titanium dioxide fine particles are further dispersed in the titanium dioxide dispersion liquid. Thus, the titanium dioxide dispersion liquid cannot be used in the use requiring higher transparency. Furthermore, the once atomized titanium dioxide fine particles start re-aggregation with progress of time. Therefore, it has been very difficult to maintain transparency stability over a long period of time.

### SUMMARY OF THE INVENTION

The present invention provides a titanium dioxide dispersion liquid in which titanium dioxide fine particles are atomized in such a manner as to satisfy light scattering and transmission performance as an optical element, clouding is suppressed, and also yellowing hardly occurs. Moreover, the invention provides a titanium dioxide dispersion liquid in which transparency stability of the once atomized titanium dioxide dispersion liquid is maintained over a long period of time.

In order to achieve the above-described purpose, the invention provides a titanium dioxide dispersion liquid in which titanium dioxide fine particles having an average primary particle diameter of 1 nm or more and 30 nm or lower are dispersed in a solution containing at least diglyme which is a solvent and trimethoxypropylsilane which is a finishing agent and the transmittance is 80% or more.

The invention also provides a titanium dioxide dispersion liquid in which titanium dioxide fine particles doped with nitrogen atoms, having an average primary particle diameter of 1 nm or more and 30 nm or lower, and containing an aggregate are dispersed in a mixed solution containing an organic dispersion medium and a silane compound represented by Formula (1) and the transmittance is 80% or more.

R¹R²ₙSi(OR³)₃₋ₙ Formula (1)

(In Formula (1), R¹ represents a C1 to C7 alkyl group, R² represents a C1 to C2 hydrocarbon group, R³ represents a C1 to C4 alkyl group, and n is 0 or 1.)

The titanium dioxide dispersion liquid in the invention is very useful as an optical organic resin because titanium dioxide fine particles are atomized in such a manner as to satisfy light scattering and transmission performance as an optical element, clouding is suppressed, and yellowing is also suppressed. Moreover, transparency stability of the once atomized titanium dioxide dispersion liquid can be maintained over a long period of time.

Further features of the present invention will become apparent from the following description of exemplary embodiments with reference to the attached drawing.

### BRIEF DESCRIPTION OF THE DRAWINGS

FIGURE is a cross sectional view of a bead mill device.

### DESCRIPTION OF THE EMBODIMENTS

### First Embodiment

As a first embodiment of the invention, a titanium dioxide dispersion liquid is shown in which titanium dioxide fine particles are atomized in such a manner as to satisfy light scattering and transmission performance as an optical element, clouding is suppressed, and yellowing is also suppressed.

The titanium dioxide dispersion liquid of the invention can be manufactured using titanium dioxide fine particles having an average primary particle diameter of 30 nm or lower as a starting material. In the invention, the average primary particle diameter refers to a diameter when converted into a ball having the same volume as that of one particle and does not refer to the diameter of an aggregate. As a method for manufacturing titanium dioxide fine particles having an average primary particle diameter of 30 nm or lower, known methods, such as a method including putting metal powder in a flame for burning under an atmosphere containing at least oxygen to thereby synthesize titanium dioxide fine particles, can be used. In general, the titanium dioxide which are fired at a high temperature has a crystal structure, such as a rutile structure or an anatase structure and has a high refractive index as compared with that of an amorphous structure, and therefore can be more suitably used as an organic optical material and an organic optical element.

The average primary particle diameter of the titanium dioxide fine particles is suitably in the range of 1 nm or more and 30 nm or lower. When the average primary particle diameter is lower than 1 nm, there is a possibility that the volume ratio of portion having poor crystallinity in the vicinity of the surface of titanium dioxide fine particles increases and a desired performance is not obtained. Therefore, the average particle size is suitably 1 nm or more. When the average particle diameter becomes larger than 30 nm, clouding due to light scattering is likely to occur when the particles are dispersed in resin with a high concentration, and therefore a transparent dispersion liquid is difficult to obtain. In contrast, when the average particle diameter is lower than 1 nm, the ratio of an amorphous portion of a particle surface layer increases, and as a result the characteristics as crystals are difficult to develop. Titanium dioxide having an average primary particle diameter of 1 nm or more and 30 nm or lower may form a plurality of aggregates, and the aggregates are removed by pulverization in dispersion treatment described later.

The titanium dioxide dispersion liquid of the invention can be obtained by performing dispersion treatment in the presence of trimethoxypropylsilane. The present inventors have found that, by performing dispersion treatment in the presence of trimethoxypropylsilane, the dispersibility of titanium dioxide in a sol is increased and yellowing which is more remarkably observed as a reduction in clouding by atomizing and dispersing the titanium dioxide with higher uniformity is not caused, and then have accomplished the invention. Even when a silane coupling agent having a reactive functional group or a halogen element which is generally suitably used, a sol having a sufficient high dispersibility with high uniformity can be produced in some cases but it is difficult to sufficiently suppress yellowing in practical use.

For the dispersion medium, an organic solvent can be used. Specifically, diglyme is suitably used. In addition to diglyme, aromatic hydrocarbons, such as toluene, benzene, and xylene, alcohols, such as methanol, ethanol, propanol, isopropanol, butanol, isobutanol, and 2-methyl-2-propanol, cycloaliphatic hydrocarbons, such as cyclopentane and cyclohexane, esters, such as ethyl acetate, butyl acetate, ethyl lactate, and butyl lactate, ketones, such as acetone and methyl ethyl ketone, amides, such as DMF, DMAc, and NMP, aliphatic hydrocarbons, such as hexane, heptane, and octane, ethers, such as diglyme, diethyl carbitol, dimethoxyethane, and anisole, halogenated hydrocarbons, such as dichloromethane and carbon tetrachloride are mentioned. Suitably, ethers can also be used. The organic solvent can be suitably selected in terms of the steam pressure at room temperature or the coloring properties of the titanium dioxide dispersion liquid to be obtained. The organic solvent can also be used alone, or in combination of two or more kinds thereof in the range where the dispersibility or the coloring properties are not impaired.

The sol may also contain resin. For example, an acrylic resin, a styrene resin, a polycarbonate resin, a polyester resin, an olefin resin, a silicone resin, a fluororesin, a norbornene resin, a polyamide resin, a polyimide resin, a urethane resin, a polyether resin, a phenol resin, an aryl resin, and the like can be used.

Moreover, the sol may contain a resin monomer having an unsaturated bond. For example, compounds having a (meth)acrylate group, a vinyl group, or the like as an unsaturated double bond in the molecules can be mentioned as the resin monomer. Usable as the resin monomer are, for example, one or two or more kinds of methyl(meth)acrylate, ethyl(meth)acrylate, propyl(meth)acrylate, isopropyl(meth)acrylate, butyl(meth)acrylate, isobutyl(meth)acrylate, tertiary butyl(meth)acrylate, pentyl(meth)acrylate, hexyl(meth)acrylate, 2-ethylhexyl(meth)acrylate, octyl(meth)acrylate, isooctyl(meth)acrylate, isodecyl(meth)acrylate, lauryl(meth)acrylate, isomyristyl(meth)acrylate, stearyl(meth)acrylate, isostearyl(meth)acrylate, 2-hydroxyethyl(meth)acrylate, hydroxypropyl(meth)acrylate, 2-hydroxybutyl(meth)acrylate, 2-methoxyethyl(meth)acrylate, 3-methoxybutyl(meth)acrylate, butoxyethyl(meth)acrylate, butanediol mono(meth)acrylate, dipropyreneglycol(meth)acrylate, methoxytriethyleneglycol(meth)acrylate, methoxydipropyreneglycol(meth)acrylate, methoxytripropyleneglycol(meth)acrylate, ethylcarbitol(meth)acrylate, 2-ethylhexylcarbitol(meth)acrylate, cyclohexyl(meth)acrylate, tertiarybutylcyclohexyl(meth)acrylate, isobornyl(meth)acrylate, dicyclopentanyl(meth)acrylate, dicyclopentenyl(meth)acrylate, dicyclopentenyloxyethyl(meth)acrylate, 2-(meth) acryloyloxyethylhexahydrophthalate, tetrahydrofurfuryl(meth)acrylate, (meth)acryloylmorpholine, dimethylaminoethyldicyclopentanyl(meth)acrylate, phenyl(meth)acrylate, phenoxyethyl(meth)acrylate, phenoxydiethyleneglycol(meth)acrylate, phenoxytetraethyleneglycol(meth)acrylate, phenoxyhexaethyleneglycol(meth)acrylate, benzyl(meth)acrylate, 2-(meth)acryloyloxyethylphthalate, 2-(meth)acryloyloxyethyl-2-hydroxyethyl phthalate, 2-(meth)acryloyloxypropylphthalate, neopentylglycolbenzoate(meth)acrylate, α-naphthyl(meth)acrylate, β-naphthyl(meth)acrylate, imide acrylate, trifluoroethyl(meth)acrylate, tetrafluoropropyl(meth)acrylate, octafluoropentyl(meth)acrylate, perfluorooctylethyl(meth)acrylate, vinyl pyrrolidone, N-vinylcaprolactam, 1-vinyl imidazole, vinyl naphthalene, vinyl carbazole, N-vinyl phthalimide, and the like.

A titania dioxide sol may further contain a dispersant, a surfactant, and the like. The type or the concentration thereof can be adjusted in accordance with the necessity of a desired optical performance in the range where the dispersibility and the coloring properties, with which scattering transmission performance as an optical element can be held, can be maintained.

In order to produce the titanium dioxide dispersion liquid of the invention, a medium type dispersion treatment device, such as a ball mill, a bead mill, and a basket mill, can be used, for example. In this case, a ceramic medium, such as a medium made of resin, glass, or zirconia or a metal medium, such as a medium made of stainless steel, can be used for the medium. Among the above, a medium made of yttrium-stabilized zirconia and a medium made of zirconia reinforced alumina, are more suitably used because impurities due to friction with a medium or a dispersing machine are hardly generated.

In the invention, titanium dioxide fine particles having an average primary particle diameter of 1 nm or more and 30 nm or lower can be used as a starting material. Therefore, for the production of a titanium dioxide dispersion liquid which is dispersed with high uniformity, dispersion treatment for pulverizing the aggregation of titanium dioxide fine particles is suitable. In order to perform pulverization treatment by a medium type dispersion device, it is necessary to use a medium having a size suitable for pulverization. For example, when the medium diameter is larger than 100 μm, the kinetic energy of the medium is excessively high as compared with the case where the medium diameter is 100 μm or lower. Therefore, a possibility of crushing primary particles themselves is higher than that in the pulverization treatment of pulverizing the aggregation of particles. Therefore, in order to obtain good dispersion performance of titanium dioxide fine particles, the use of a medium having a medium diameter of 100 μm or lower is suitable in which the kinetic energy of the medium is low and which can perform pulverization treatment. More suitably, it is considered that the use of a medium having a particle diameter of 30 μm or lower in which the energy amount is lower is suitable.

FIGURE illustrates a medium type dispersion device. In FIGURE, when performing dispersion treatment of titanium dioxide fine particles using a device which rotates a stirring shaft 2 with a blade, such as a bead mill, to stir a medium, titanium dioxide fine particles, a finishing agent, a dispersion medium, and a medium (beads) is introduced into a dispersion container 1. Thereafter, a medium having a medium diameter of 100 μm or lower and inorganic particles contact by the rotation of the stirring axis 2 with a blade, so that the aggregated titanium dioxide fine particles are pulverized and dispersed. In the drawing, 7 denotes a mixture of inorganic fine particles. 8 denotes a cooling water inlet which supplies a cooling liquid for cooling the dispersion container 1. 9 denotes a cooling water outlet. 11 denotes a separator which separates a solution which is dispersed by the dispersion container 1. 12 denotes a dispersion container outlet which sends the solution separated by the separator into an exhaust pipe 4. 13 denotes a dispersion container inlet which sends again the solution which is dispersed through a supersonic vibration device 10 into the dispersion container 1. In this case, the supersonic vibration device 10 may be provided for assisting the pulverization treatment. The supersonic treatment can be applied to any one or all of the dispersion container 1, a discharge pipe 4, a tank 3, and a supply pipe 5, and prevents the re-aggregation of pulverized titanium dioxide fine particles.

The titanium dioxide dispersion liquid of the invention dissolves resin, and then use the same as a coating liquid or the like to thereby form a coating film and can be formed into an optical element having a desired shape by volatilizing an unnecessary solvent or the like, and then subjecting the resultant titanium dioxide dispersion liquid to various known molding methods. The resin is variously selected without limitation in the range where the dispersibility or the coloring properties of titanium dioxide fine particles can be maintained in accordance with desired characteristics of an optical element. For example, as the resin which can be dissolved in the titanium dioxide dispersion liquid, the above-mentioned resin can be mentioned. In that case, a dispersant, a surfactant, a leveling agent, a mold release agent, an antioxidant, a light absorbent, a coloring material, and the like may also be contained. The type or the concentration thereof can be adjusted in accordance with the necessity of a desired optical performance in the range where the dispersibility and the coloring properties, with which scattering transmission performance as an optical element can be held, can be maintained.

### Example 1

In a dispersion container of a bead mill having 400 g of zirconia beads having a particle size of 30 μm, titanium dioxide powder having a primary particle diameter of 15 nm, trimethoxypropylsilane, and 300 mL of diglyme were placed. In that case, the titanium dioxide concentration was adjusted to 1% and the trimethoxypropylsilane concentration was adjusted to 2%. Subsequently, bead mill treatment was performed for 1440 minutes under the conditions of the number of rotations of a stirring shaft of 3485 rpm and a pump flow rate of 10 kg/h while applying supersonic vibration to the tank at a frequency of 35 kHz and an output of 100 W. The obtained titanium dioxide dispersion liquid was evaluated by the evaluation method described later. The evaluation results are shown in Table 1.

### Evaluation of Light Transmittance and Scattering Ratio

The titanium dioxide dispersion liquid was put in a quartz cell having an optical path length of 2 mm and was measured using a spectrophotometer U-4000 (product name) manufactured by Hitachi High-Technologies Corporation. The transmittance was evaluated as follows: the transmittance at a wavelength of 430 nm of 80% or more was evaluated as good and the transmittance at a wavelength of 430 nm of lower than 80% was evaluated as poor. The scattering ratio was evaluated as follows: the scattering ratio of lower than 1% was evaluated as good and the scattering ratio of 1% or more was evaluated as poor.

### Example 2

Example 2 was carried out under the condition that the primary particle diameter of the titanium dioxide powder of Example 1 was 30 nm. The conditions other than the primary particle diameter of the titanium dioxide powder are the same as those of Example 1. The obtained titanium dioxide dispersion liquid was evaluated by the same method as that of Example 1. The evaluation results are shown in Table 1.

### Example 3

To the titanium dioxide dispersion liquid obtained in Example 1, PO modified neopentylglycol diacrylate and 1-hydroxy-cyclohexyl-phenyl-ketone were added, and then the diglyme in the dispersion liquid obtained in Example 1 was distilled off while reducing the pressure from the atmospheric pressure to 2 hPs in 24 hours using a rotary evaporator. The water bath temperature in that case was 50° C., and the distilled diglyme was removed out of the system as appropriate. In the obtained optical material, the titanium dioxide concentration was adjusted to 5% and the photopolymerization initiator was adjusted to 1.4%.

A spacer was disposed between two glass substrates facing each other, and then the optical material was casted to the center of the glass substrates. Thereafter, the material was developed while closely contacting the glass substrates, and was irradiated with ultraviolet rays (50 mW/cm, 2,200 seconds) to be cured. The thickness of the manufactured film-shaped optical resin molded product was 30 μm and had a transparency satisfying light scattering transmission performance as a light transmission organic optical element.

### Comparative Example 1

Comparative Example 1 was carried out under the condition that the trimethoxypropylsilane of Example 1 was changed to methacryloxypropyltrimethoxysilane. The obtained titanium dioxide dispersion liquid was evaluated by the same method as that of Example 1. The evaluation results are shown in Table 1.

### Comparative Example 2

Comparative Example 1 was carried out under the condition that the trimethoxypropylsilane of Example 1 was changed to trifluoropropyltrimethoxysilane. The obtained titanium dioxide dispersion liquid was evaluated by the same method as that of Example 1. The evaluation results are shown in Table 1.

### Comparative Example 3

Comparative example 3 was carried out under the condition that the primary particle diameter of the titanium dioxide powder of Example 1 was 180 nm. The conditions other than the primary particle diameter of titanium dioxide powder are the same as those of Example 1. The obtained titanium dioxide dispersion liquid was evaluated by the same method as that of Example 1. The evaluation results are shown in Table 1.

Table 1 shows that Examples 1 and 2 are the cases where the dispersion treatment was carried out in the presence of trimethoxypropylsilane, in which the titanium dioxide dispersion liquid exhibited good dispersibility and noticeable yellowing was not confirmed. Comparative Examples 1 and 2 are the cases where the dispersion treatment was carried out in the presence of methacryloxypropyltrimethoxysilane and trifluoropropyltrimethoxysilane, respectively, as compared with Example 1 in which the titanium dioxide fine particles were uniformly dispersed but the titanium dioxide dispersion liquid was colored yellow and the transmittance at a wavelength of 430 nm used as the index indicating the coloring degree was lower than 80%. Comparative Example 3 is the case where the primary particle diameter of the titanium dioxide fine particles was 180 nm, in which the obtained titanium dioxide dispersion liquid became cloudy and also the transmittance scattering ratio values were insufficient.

TABLE 1

Evaluation items

| | Transmittance | Scattering ratio |
|---|---|---|
| | (%)*¹ | (%)*² |
| Example 1 | 85 | 0.6 |
| Example 2 | 82 | 0.9 |
| Comparative Example 1 | 45 | 2.2 |
| Comparative Example 2 | 52 | 4.3 |
| Comparative Example 3 | 40 | 12 |

*¹Light transmittance at a wavelength of 430 nm
*²Light scattering ratio at a wavelength of 430 nm

### Second Embodiment

As a second embodiment of the invention, a titanium dioxide dispersion liquid is shown in which titanium dioxide fine particles are atomized in such a manner as to satisfy light scattering transmission performance as an optical element, clouding is suppressed, and also the transparency stability of the once atomized titanium dioxide dispersion liquid is maintained over a long period of time. In the following description, a doped titanium dioxide means titanium dioxide doped with nitrogen atoms.

The titanium dioxide dispersion liquid in the invention contains titanium dioxide fine particles doped with nitrogen atoms and having an average particle diameter of 1 nm or more and 50 nm or lower, the silane compound represented by Formula (1), and an organic dispersion medium.

R¹R²ₙSi(OR³)₃₋ₙ Formula (1)

(In Formula (I), R¹ represents a C1 to C7 alkyl group, R² represents a C1 to C2 hydrocarbon group, R³ represents a C1 to C4 alkyl group, and n is 0 or 1.)
As doping atoms, sulfur, phosphorous, selenium, and the like are mentioned in addition to a nitrogen atom, but the doping atoms are not limited thereto. Sulfur and nitrogen are suitable considering the toxicity, the ease of synthesizing, industrial convenience, and the like. When titanium dioxide is doped with sulfur atoms, the refractive-index-dispersion characteristics (high Abbe) peculiar to the sulfur atoms are imparted to the titanium dioxide. Therefore, the refractive-index-dispersion characteristics of the titanium dioxide considerably deviate from the refractive-index-dispersion characteristics intrinsic to the titanium dioxide. Therefore, nitrogen is more suitable.

The average particle diameter of the doped titanium dioxide is not particularly limited insofar as the transmittance and the scattering ratio in a dispersion medium are in such a range that the doped titanium dioxide can be utilized as an organic optical element material and the dispersion state can be stably held, and is suitably 1 nm or more and 30 nm or lower. When the average particle diameter becomes larger than 30 nm, clouding due to light scattering is likely to occur when dispersed in resin with a high concentration, and therefore a transparent dispersion liquid becomes hard to obtain. In contrast, when the average particle diameter becomes lower than 1 nm, the ratio of an amorphous portion of a particle surface layer increases, and as a result the characteristics as a crystal become difficult to develop. Moreover, in order to efficiently recover abnormal dispersion characteristics of a refractive index which is reduced by a blue shift upon atomization by a red shift upon hetero atom doping, a larger number of hetero atoms are suitably doped. Since particles having a large surface area can be doped with a larger number of hetero atoms, the average particle diameter of the doped titanium dioxide is more suitably 1 nm or more and 30 nm or lower.

As the crystal structure of titanium dioxide, rutile, anatase, and the like are mentioned but the structure is not limited thereto. As a method for synthesizing the doped titanium dioxide, there are two methods of a method for directly synthesizing the same by a sol-gel reaction and a method for synthesizing the same by adding a doping agent to titanium dioxide synthesized beforehand, and both the methods may be acceptable. As the method for directly synthesizing the nitrogen doped titanium dioxide by a sol-gel reaction among methods for synthesizing nitrogen doped titanium dioxide, a method for synthesizing the same from titanium trichloride and aqueous ammonia is mentioned, for example (Japanese Patent Laid-Open No. 2001-072419). However, when directly synthesizing the same by a sol-gel reaction, heating in a reaction process becomes insufficient, so that only doped titanium dioxide having a low crystallinity is merely synthesized. In contrast, in the case of the method for synthesizing the same by adding a doping agent to titanium dioxide synthesized beforehand, the titanium dioxide can undergo firing or a plasma atmosphere, so that doped titanium dioxide which is highly crystallized can be synthesized. Therefore, the method for synthesizing the same by adding a doping agent to titanium dioxide synthesized beforehand is suitable as the synthesizing method. The method for synthesizing the same by adding a doping agent to titanium dioxide synthesized beforehand is not particularly limited. In addition to known methods described in literatures and the like, a method for synthesizing the same by heat-treating titanium oxide particles at 700° C. under an ammonia atmosphere (Japanese Patent Laid-Open No. 2001-207082), a method for synthesizing the same by performing plasma treatment under a nitrogen gas atmosphere (Japanese Patent Laid-Open No. 2000-140636), and the like are mentioned, for example.

In Formula (1), R¹ is suitably one having 1 to 7 carbon atoms. When the number of carbon atoms is 8 or more, a process for dispersing the doped titanium dioxide in an organic dispersion medium is prolonged under the influence of steric hindrance. Therefore, one having 8 or more carbon atoms is not suitable. Therefore, specifically, R¹ is methyl, ethyl, vinyl, propyl, 2-propyl, propenyl, butyl, 3-mercaptopropyl, 3-acryl oxypropyl, 3-methacryl oxypropyl, 3-(2-oxiranylmethoxy)propyl, and the like but R¹ is not limited thereto. Considering the transmittance or the like of a dispersion liquid, methyl, ethyl, vinyl, propyl, 2-propyl, propenyl, and butyl are suitable. In Formula (1), R² is suitably one having 1 to 2 carbon atoms. When the number of carbon atoms is 3 or more, a process for dispersing the doped titanium dioxide in an organic dispersion medium is prolonged under the influence of steric hindrance. Therefore, one having 3 or more carbon atoms is not suitable. Specifically, methyl, ethyl, and vinyl are mentioned. In Formula (1), R³ is suitably one having 1 to 4 carbon atoms. When the number of carbon atoms is 5 or more, a process for dispersing the doped titanium dioxide in an organic dispersion medium is prolonged under the influence of steric hindrance. Therefore, one having 5 or more carbon atoms is not suitable. Therefore, specifically, methyl, ethyl, propyl, 2-propyl, butyl, and the like are mentioned but R³ is not limited thereto. Considering a preparation time of the dispersion liquid, methyl and ethyl are suitable.

Mentioned as the organic dispersion medium are an organic solvent containing an oxygen atom and a hydrocarbon organic solvent but the organic dispersion medium is not limited thereto. Mentioned as the organic solvent containing an oxygen atom are, for example, alcohols, such as methanol, ethanol, 2-propanol, butanol, s-butyl alcohol, t-butyl alcohol, diethylene glycol monomethyl ether, phenol, and cresol, ethers, such as diethylether, t-butyl methyl ether, anisole, mesitylene, diglyme, ethylene glycol dimethyl ether, and ethylene glycol diethylether, esters, such as ethyl acetate, methyl acetate, methyl propionate, ethyl propionate, and 3-methoxy methyl propionate, and ketones, such as methyl isobutyl ketone, diethyl ketone, and methyl ethyl ketone, but the organic solvent containing an oxygen atom is not limited thereto. Considering yellowing and long-term stability of the dispersion liquid, 3-methoxy methyl propionate, diglyme, and methyl isobutyl ketone are suitable. Mentioned as the hydrocarbon organic solvent are, for example, hexane, heptane, cyclohexane, tetralin, benzene, toluene, xylene, mesitylene, and the like but the hydrocarbon organic solvent is not limited thereto. Considering long-term stability of the dispersion liquid, toluene is suitable.

As a method for preparing the titanium dioxide dispersion liquid containing the organic dispersion medium of the doped titanium dioxide fine particles, two methods are typically mentioned: a method for preparing the same by dispersing powdered doped titanium dioxide fine particles in an organic dispersion medium by a mechanical technique and a method for directly preparing the same in an organic dispersion medium. Either method may be selected. As a typical example of the method for directly preparing the titanium dioxide dispersion liquid in an organic dispersion medium, a sol-gel reaction is common in which the preparation is performed in alcohol or an organic dispersion medium containing alcohol. However, the doped titanium dioxide synthesized by the sol-gel reaction is merely heated to about the boiling point of a solvent at the highest, and therefore crystals having a low crystallinity degree are formed in many cases. In contrast, when preparing the titanium dioxide dispersion liquid from powdered doped titanium dioxide, the powdered doped titanium dioxide undergoes a firing process or a plasma-heating process when preparing the titanium dioxide serving as a raw material. Therefore, a dispersion liquid containing crystals having a high crystallinity degree can be prepared. Therefore, the method for preparing the titanium dioxide dispersion liquid by dispersing the powdered doped titanium dioxide fine particles in an organic dispersion medium by a mechanical technique is suitable.

As a method for obtaining a mixed solution in which the powdered doped titanium dioxide is mechanically dispersed in a solution containing an organic dispersion medium, dispersion treatment for pulverizing an aggregate of titanium dioxide fine particles is suitable. Mill devices, such as a jet mill, a ball mill, a bead mill, and a disk mill, an ultrasonic homogenizer, and the like are mentioned but the device is not limited thereto. Considering the preparation of a transparent dispersion liquid, a bead mill which is a medium type dispersion device illustrated in FIGURE described above is suitable. The bead diameter of beads to be used is suitably 15 μm or more and 30 μm or lower for obtaining a dispersion liquid with high transparency. When the bead diameter becomes excessively larger than 30 μm, not only the pulverization of an aggregate but crushing of particles themselves occur, so that the transparency of the dispersion liquid is lost under the influence of the re-aggregation caused by the crushing. However, beads having a diameter of lower than 15 μm are not marketed at present. Therefore, the dispersion thereof cannot be examined. By treating the dispersion liquid of the doped titanium dioxide by ultrasonic waves, a homogenizer, or the like during bead mill treatment, shortening of the dispersion process can also be achieved.

When mechanically dispersing the doped titanium dioxide in an organic dispersion medium, the silane compound represented by Formula (I) is suitably added. The addition amount is suitably about 50% by weight to about 300% by weight based on the doped titanium dioxide. When the addition amount decreases, the transparency or the stability of the dispersion liquid decreases. In contrast, when the addition amount is excessively large, the concentration of the doped titanium dioxide decreases when mixed with an organic resin. Therefore, such an addition amount is not suitable. The addition amount is more suitably 100% by weight to 200% by weight. Even when a titanium coupling agent, such as dodecylbenzene sulfonyloxytitanium triisopropoxide and titanium triisopropoxide oleate is used in addition to the silane compound represented by Formula (1), the dispersion liquid can be prepared. The addition amount in that case is suitably about 10% by weight to about 100% by weight based on the doped titanium dioxide. When the addition amount is excessively small, the transparency or the stability of the dispersion liquid remarkably decreases. In contrast, when the addition amount is excessively large, the aggregation of the titanium coupling agent is likely to occur, so that the transparency of the dispersion liquid decreases.

The doped titanium dioxide fine particle dispersion liquid and the organic resin may be mixed to be used as an optical element material. Mentioned as the organic resin are, for example, (meth)acrylate compounds, such as 1,3-adamantane diol dimethacrylate, 1,3-adamantane dimethanol dimethacrylate, tricyclodecanedimethanol diacrylate, pentaerythritol tetraacrylate, propoxylated neopentyl glycol diacrylate, dipropyrene glycol diacrylate, ethoxylated bisphenol A dimethacrylate, tris(2-hydroxyethyl)isocyanurate triacrylate, 2(2-ethoxy ethoxy)ethyl acrylate, stearyl acrylate, tetrahydrofurfuryl acrylate, 2-phenoxy ethyl acrylate, isodecyl acrylate, isobonyl acrylate, isobonyl methacrylate, 1,3-butylene glycol diacrylate, 1,4-butanediol diacrylate, diethylene glycol diacrylate, 1,6-hexanediol diacrylate, triethylene glycol diacrylate, tripropylene glycol diacrylate, dipropyrene glycol diacrylate, triethylene glycol dimethacrylate, ethylene glycol dimethacrylate, tetraethylene glycol dimethacrylate, 1,4-butanediol dimethacrylate, diethylene glycol dimethacrylate, 1,6-hexanediol dimethacrylate, tripropylene glycol dimethacrylate, dipropyrene glycol dimethacrylate, trimethylolpropane trimethacrylate, 9,9-bis[4-(2-acryloyloxyethoxy)phenyl]fluorene, 9,9-bis[4-(2-methacryloyloxy ethoxy)phenyl]fluorene, 9,9-bis[4-(2-acryloyl oxy)phenyl]fluorene, 9,9-bis[4-(2-methacryloyloxy)phenyl]fluorene, benzyl acrylate, benzyl methacrylate, butoxyethyl acrylate, butoxymethyl methacrylate, cyclohexyl acrylate, cyclohexyl methacrylate, 2-hydroxyethyl acrylate, 2-hydroxymethyl methacrylate, glycidyl acrylate, glycidyl methacrylate, phenoxyethyl acrylate, phenoxyethyl methacrylate, phenylmethacrylate, ethylene glycol diacrylate, ethylene glycol dimethacrylate, diethylene glycol diacrylate, diethylene glycol dimethacrylate, triethylene glycol diacrylate, triethylene glycol dimethacrylate, tetraethylene glycol diacrylate, tetraethylene glycol dimethacrylate, polyethylene glycol diacrylate, polyethylene glycol dimethacrylate, neopentylglycol diacrylate, neopentylglycol dimethacrylate, ethylene glycol bisglycidyl acrylate, ethylene glycol bisglycidyl methacrylate, bisphenol A diacrylate, bisphenol A dimethacrylate, 2,2-bis(4-acryloxy ethoxy phenyl)propane, 2,2-bis(4-methacryloxy ethoxy phenyl)propane, 2,2-bis(4-acryloxy diethoxyphenyl)propane, 2,2-bis(4-methacryloxy diethoxyphenyl)propane, bisphenol F diacrylate, bisphenol F dimethacrylate, 1,1-bis(4-acryloxy ethoxy phenyl)methane, 1,1-bis(4-methacryloxy ethoxy phenyl)methane, 1,1-bis(4-acryloxy diethoxyphenyl)methane, 1,1-bis(4-methacryloxy diethoxyphenyl)methane, 1,1-bis(4-acryloxy ethoxy phenyl)sulfone, 1,1-bis(4-methacryloxy ethoxy phenyl)sulfone, 1,1-bis(4-acryloxy diethoxyphenyl)sulfone, 1,1-bis(4-methacryloxy diethoxyphenyl)sulfone, dimethylol tricyclodecane diacrylate, trimethylolpropane triacrylate, trimethylolpropane trimethacrylate, glycerol diacrylate, glycerol dimethacrylate, pentaerythritol triacrylate, pentaerythritol tetraacrylate, pentaerythritol tetramethacrylate, methylthio acrylate, methylthio methacrylate, phenylthio acrylate, benzylthio methacrylate, xylylene dithiol diacrylate, xylylene dithiol dimethacrylate, mercaptoethyl sulfide diacrylate, and mercaptoethyl sulfide dimethacrylate, allyl compounds, such as allyl glycidyl ether, diallyl phthalate, diallyl terephthalate, diallyl isophthalate, diallyl carbonate, and diethylene glycol bisallyl carbonate, vinyl compounds, such as styrene, chlorostyrene, methylstyrene, bromostyrene, dibromostyrene, divinylbenzene, and 3,9-divinylspiropy(m-dioxane), silane compounds, such as trimethoxy(7-octenyl)silane, 3-(trimethoxysilyl)propylacrylate, 3-(trimethoxysilyl)propyl-2-methylacrylate, and [2-(3-cyclohexene-1-yl)ethyl](triethoxy)silane, diisopropenyl benzene, and the like. The organic resin is not limited thereto.

In this case, the generated optical element material can be mixed with a polymerization initiator to be utilized also as a polymerizable composition, such as an organic optical element. As the polymerization initiator, one which generates radical species by light irradiation, one which generates cationic species by light irradiation, one which generates radical species by heat, and the like are mentioned but the polymerization initiator is not limited thereto. Mentioned as the polymerization initiator which generates radical species by light irradiation are 2-benzyl-2-dimethylamino-1-(4-morpholinophenyl)-1-butanone, 1-hydroxy-cyclohexyl phenyl ketone, 2-hydroxy-2-methyl-1-phenyl-propane-1-one, bis(2,4,6-trimethyl benzoyl)-phenylphosphine oxide, 4-phenylbenzophenone, 4-phenoxybenzophenone, 4,4′-diphenylbenzophenone, 4,4′-diphenoxybenzophenone and the like but the polymerization initiator is not limited thereto. As the polymerization initiator which generates cationic species by light irradiation, Irgacure 250 is mentioned as a suitable polymerization initiator but the polymerization initiator is not limited thereto. Mentioned as the polymerization initiator which generates radical species by heat are azo compounds, such as azobisisobutyronitrile (AIBN), peroxides, such as benzoyl peroxide, t-butylperoxypivalate, t-butylperoxy neohexanoate, t-hexylperoxy neohexanoate, t-butylperoxy neodecanoate, t-hexylperoxy neodecanoate, cumylperoxy neohexanoate, and cumylperoxy neodecanoate, are mentioned, but the polymerization initiator is not limited thereto.

When emitting ultraviolet rays or the like to initiate polymerization, a known sensitizer or the like can also be used. Mentioned as typical sensitizers are benzophenone, 4,4-diethyl amino benzophenone, 1-hydroxy cyclohexylphenyl ketone, p-dimethylamino isoamyl benzoate, 4-dimethylamino methyl benzoate, benzoin, benzoin ethyl ether, benzoin isobutyl ether, benzoin isopropyl ether, 2,2-diethoxy acetophenone, methyl o-benzoylbenzoate, 2-hydroxy-2-methyl-1-phenylpropane-1-one, acyl phosphine oxide, and the like are mentioned.

The addition ratio of the photopolymerization initiator to a polymerizable resin component can be selected as appropriate in accordance with the light irradiation dose and also an additional heating temperature and also be adjusted in accordance with a target average molecular weight of a polymer to be obtained. When utilizing the photopolymerization initiator for curing and molding the optical material according to the invention, the addition amount of the photopolymerization initiator is suitably selected in the range of 0.01 to 10.00% by weight based on the polymerizable component. The photopolymerization initiator can be used alone or in combination of two or more kinds thereof depending on the reactivity of resin and the wavelength of light irradiation.

The organic resin may be thermoplastic. For example, mentioned are polyolefin resin, such as an ethylene homopolymer, a random or block copolymer of ethylene and one or two or more kinds of α-olefins, such as propylene, 1-butene, 1-pentene, 1-hexene, and 4-methyl-1-pentene, a random or block copolymer of ethylene and one or two or more kinds of vinyl acetate, acrylic acid, methacrylic acid, methyl acrylate, and methyl methacrylate, a propylene homopolymer, a random or block copolymer of propylene and α-olefins, other than propylene, such as 1-butene, 1-pentene, 1-hexene, and 4-methyl-1-pentene, a 1-butene homopolymer, an ionomer resin, and a mixture of these polymers; hydrocarbon resin, such as petroleum resin and terpene resin; polyester resin, such as polyethylene terephthalate, polybutylene terephthalate, and polyethylenenaphthalate; polyamide resin, such as nylon 6, nylon 66, nylon 11, nylon 12, nylon 610, nylon 6/66, nylon 66/610, and nylon MXD; acrylic resin, such as polymethyl methacrylate; styrene acrylonitrile resin, such as polystyrene, a styrene-acrylonitrile copolymer, a styrene-acrylonitrile-butadiene copolymer, and polyacrylonitrile; polyvinyl alcohol resin, such as polyvinyl alcohol and an ethylene vinyl alcohol copolymer, polycarbonate resin; polyketone resin; polymethylene oxide resin; polysulfone resin; polyimide resin; polyamide imide resin, and the like. These resins can be used alone or as a mixture of two or more kinds thereof.

A process for manufacturing an organic optical element which is a molded product of the above-described polymerizable composition is as follows: when forming a thin layer structure having a small film thickness on a light transmission material to be utilized as a substrate, a glass substrate is utilized, for example, when utilizing a metal material as a corresponding die, the polymerizable composition exhibiting fluidity is poured therebetween, and then the polymerizable composition is slightly pressed, thereby achieving die molding. The polymerizable composition is polymerized while maintaining the state. The light irradiation for use in the polymerization reaction is performed utilizing light, which has a suitable wavelength corresponding to the mechanism resulting from the radical generation utilizing the photopolymerization initiator, usually UV light or visible light. For example, light is uniformly emitted to raw materials, such as a molded optical material preparing monomer, through the light transmission material to be utilized for the substrate, specifically a glass substrate. The quantity of light to be emitted is selected as appropriate in accordance with the mechanism resulting from the radical generation utilizing the photopolymerization initiator and the content ratio of the photopolymerization initiator to be compounded.

In contrast, in the production of the organic optical element which is a molded product of the polymerizable composition by the photopolymerization reaction, it is suitable that the light to be emitted is uniformly emitted to the entire raw material, such as the die-molded monomer. Therefore, as the light irradiation to be utilized, it is more suitable to select light having a wavelength capable of uniformly emitting through the light transmission material to be utilized for the substrate, e.g., a glass substrate. In that case, an aspect in which the total thickness of the molded product of the optical material formed on the light transmission material to be utilized for the substrate is reduced is more suitable for the invention. Similarly, the molded product can also be produced by a thermal polymerization method. In this case, it is desirable that the entire temperature is more uniform. An aspect in which the total thickness of the molded product of the polymerizable composition formed on the light transmission material to be utilized for the substrate is reduced is more suitable for the invention. When increasing the total thickness of the molded product of the polymerizable composition to be formed, an irradiation dose, an irradiation intensity, a light source, and the like need to select further considering the film thickness, the absorption of the resin component, and the absorption of the fine particle component.

In contrast, a process for forming the organic optical element which is a molded product of a mixed composition with thermoplastic resin is not particularly limited. In order to obtain a molded product excellent in the characteristics, such as low birefringent properties, mechanical strength, and dimension accuracy, melt molding is particularly suitable. As the melt molding method, commercially available press molding, commercially available extrusion molding, commercially available injection molding, and the like are mentioned. From the viewpoint of moldability and productivity, the injection molding is suitable. The molding conditions in the molding process are selected as appropriate in accordance with the intended use or a molding method. The temperature of a resin composition in the injection molding is in the range of suitably 150° C. to 400° C., more suitably 200° C. to 350° C., and particularly suitably 200° C. to 330° C. from the viewpoint of imparting moderate fluidity to resin during molding to prevent the occurrence of a sink or distortion of a molded product and also the occurrence of a silver streak due to thermal decomposition of resin and further effectively preventing yellowing of a molded product.

A detailed implementation system of the titanium dioxide dispersion liquid containing the titanium dioxide fine particles doped with hetero atoms, the silane compound represented by Formula (I), and the organic dispersion medium is described in the following examples.

### EXAMPLES

Next, the invention is described in detail with reference to examples. The invention is not limited to the examples. As the nitrogen doped titanium dioxide described in the examples, one synthesized by a known method is purchased and utilized.

### Example 4

In a dispersion container of a bead mill having 400 g of zirconia beads having a particle size of 30 μm, nitrogen doped titanium dioxide powder (anatase) having a primary particle diameter of 15 nm, trimethoxypropylsilane, and 300 mL of diglyme were placed. In that case, the titanium dioxide concentration was adjusted to 1% by weight and the trimethoxypropylsilane concentration was adjusted to 2% by weight. Subsequently, bead mill treatment was performed for 240 minutes under the conditions of the number of rotations of a stirring shaft of 3485 rpm and a pump flow rate of 10 kg/h while applying supersonic vibration to the tank at a frequency of 35 kHz and an output of 100 W. The obtained nitrogen doped titanium dioxide dispersion liquid was evaluated by the evaluation method described later. The evaluation results are shown in Table 2.

### Evaluation of Light Transmittance and Scattering Ratio

The titanium dioxide dispersion liquid was put in a quartz cell having an optical path length of 2 mm and was measured using a spectrophotometer U-4000 (product name) manufactured by Hitachi High-Technologies Corporation. The transmittance was evaluated as follows: the transmittance at a wavelength of 430 nm of 80% or more was evaluated as good and the transmittance at a wavelength of 430 nm of lower than 80% was evaluated as poor. The scattering ratio was evaluated as follows: the scattering ratio of lower than 3% was evaluated as good and the scattering ratio of 3% or more was evaluated as poor.

### Example 5

A dispersion liquid was obtained in the same manner as in the method described in Example 4, except changing the zirconia beads having a particle size of 30 μm to 15 μm zirconia beads. The evaluation results are shown in Table 2.

### Example 6

A dispersion liquid was obtained in the same manner as in the method described in Example 4, except changing the nitrogen doped titanium dioxide powder (anatase) having a primary particle diameter of 15 nm to nitrogen doped titanium dioxide powder (anatase) having a primary particle diameter of 50 nm. The evaluation results are shown in Table 2.

### Example 7

A dispersion liquid was obtained in the same manner as in the method described in Example 4, except changing the diglyme 3-methoxy methyl propionate. The evaluation results are shown in Table 2.

TABLE 2

| | Ex. 4 | Ex. 5 | Ex. 6 | Ex. 7 |
|---|---|---|---|---|
| Transmittance | 95 | 96 | 92 | 89 |
| [%] | | | | |
| Scattering | 0.58 | 0.58 | 1.2 | 1.6 |
| ratio [%] | | | | |

### Example 8

A dispersion liquid was obtained in the same manner as in the method described in Example 4, except changing the diglyme to methyl isobutyl ketone. The evaluation results are shown in Table 3.

### Example 9

A dispersion liquid was obtained in the same manner as in the method described in Example 4, except changing the diglyme to toluene. The evaluation results are shown in Table 3.

### Example 10

A dispersion liquid was obtained in the same manner as in the method described in Example 4, except changing the trimethoxypropylsilane to trimethoxymethylsilane. The evaluation results are shown in Table 3.

### Example 11

A dispersion liquid was obtained in the same manner as in the method described in Example 4, except changing the trimethoxypropylsilane to trimethoxyethylsilane. The evaluation results are shown in Table 3.

### Example 12

A dispersion liquid was obtained in the same manner as in the method described in Example 4, except changing the trimethoxypropylsilane to triethoxymethylsilane. The evaluation results are shown in Table 3.

TABLE 3

| | Ex. 8 | Ex. 9 | Ex. 10 | Ex. 11 | Ex. 12 |
|---|---|---|---|---|---|
| Transmittance | 93 | 88 | 90 | 96 | 96 |
| [%] | | | | | |
| Scattering | 1.2 | 1.8 | 1.2 | 0.56 | 0.55 |
| ratio [%] | | | | | |

### Example 13

A dispersion liquid was obtained in the same manner as in the method described in Example 4, except changing the trimethoxypropylsilane to triethoxyvinylsilane. The evaluation results are shown in Table 4.

### Example 14

A dispersion liquid was obtained in the same manner as in the method described in Example 4, except changing the trimethoxypropylsilane to triethoxyethylsilane. The evaluation results are shown in Table 4.

### Example 15

A dispersion liquid was obtained in the same manner as in the method described in Example 4, except changing the trimethoxypropylsilane to triethoxyallylsilane. The evaluation results are shown in Table 4.

### Example 16

A dispersion liquid was obtained in the same manner as in the method described in Example 4, except changing the trimethoxypropylsilane to triethoxypropylsilane. The evaluation results are shown in Table 4.

### Example 17

A dispersion liquid was obtained in the same manner as in the method described in Example 4, except changing the trimethoxypropylsilane to tripropoxymethylsilane. The evaluation results are shown in Table 4.

TABLE 4

| | Ex. 13 | Ex. 14 | Ex. 15 | Ex. 16 | Ex. 17 |
|---|---|---|---|---|---|
| Transmittance | 96 | 95 | 95 | 94 | 95 |
| [%] | | | | | |
| Scattering | 0.55 | 0.65 | 0.71 | 1.0 | 0.93 |
| ratio [%] | | | | | |

### Example 18

A dispersion liquid was obtained in the same manner as in the method described in Example 4, except changing the trimethoxypropylsilane to triethoxy(2-propyl)silane. The evaluation results are shown in Table 5.

### Example 19

A dispersion liquid was obtained in the same manner as in the method described in Example 4, except changing the trimethoxypropylsilane to triethoxycyclopentylsilane. The evaluation results are shown in Table 5.

### Example 20

A dispersion liquid was obtained in the same manner as in the method described in Example 4, except changing the trimethoxypropylsilane to triethoxycyclohexylsilane. The evaluation results are shown in Table 5.

### Example 21

A dispersion liquid was obtained in the same manner as in the method described in Example 4, except changing the trimethoxypropylsilane to triethoxy[3-(2-oxiranylmethoxy)propyl]silane. The evaluation results are shown in Table 5.

### Example 22

A dispersion liquid was obtained in the same manner as in the method described in Example 4, except changing the trimethoxypropylsilane to dimethoxy[3-(2-oxiranylmethoxy)propyl]methyl silane. The evaluation results are shown in Table 5.

TABLE 5

| | Ex. 18 | Ex. 19 | Ex. 20 | Ex. 21 | Ex. 22 |
|---|---|---|---|---|---|
| Transmittance | 94 | 89 | 86 | 83 | 82 |
| [%] | | | | | |
| Scattering | 1.3 | 1.8 | 2.6 | 2.7 | 2.9 |
| ratio [%] | | | | | |

### Example 23

A dispersion liquid was obtained in the same manner as in the method described in Example 4, except changing the trimethoxypropylsilane to trimethoxy(3-acryloxypropyl)silane. The evaluation results are shown in Table 6.

### Example 24

A dispersion liquid was obtained in the same manner as in the method described in Example 4, except changing the trimethoxypropylsilane to trimethoxy(3-methacryloxypropyl)silane. The evaluation results are shown in Table 6.

### Example 25

A dispersion liquid was obtained in the same manner as in the method described in Example 4, except changing the trimethoxypropylsilane to dimethoxy(3-acryloxypropyl)methylsilane. The evaluation results are shown in Table 6.

### Example 26

A dispersion liquid was obtained in the same manner as in the method described in Example 4, except changing the trimethoxypropylsilane to dimethoxy(3-methacryloxypropyl)methylsilane. The evaluation results are shown in Table 6.

### Example 27

A dispersion liquid was obtained in the same manner as in the method described in Example 4, except changing the trimethoxypropylsilane to dimethoxydimethylsilane. The evaluation results are shown in Table 6.

TABLE 6

| | Ex. 23 | Ex. 24 | Ex. 25 | Ex. 26 | Ex. 27 |
|---|---|---|---|---|---|
| Transmittance | 83 | 84 | 85 | 81 | 82 |
| [%] | | | | | |
| Scattering | 2.8 | 2.6 | 2.2 | 2.8 | 2.8 |
| ratio [%] | | | | | |

### Example 28

A dispersion liquid was obtained in the same manner as in the method described in Example 4, except changing the trimethoxypropylsilane to dimethoxymethylvinylsilane. The evaluation results are shown in Table 7.

### Example 29

A dispersion liquid was obtained in the same manner as in the method described in Example 4, except changing the trimethoxypropylsilane to dimethoxycyclohexylmethylsilane. The evaluation results are shown in Table 7.

### Example 30

A dispersion liquid was obtained in the same manner as in the method described in Example 4, except changing the trimethoxypropylsilane to dimethoxy(3-mercaptopropyl)methylsilane. The evaluation results are shown in Table 7.

### Example 31

In a dispersion container of a bead mill having 400 g of zirconia beads having a particle size of 30 μm, nitrogen doped titanium dioxide powder (anatase) having a primary particle diameter of 15 nm, trimethoxypropylsilane, and 300 mL of diglyme were placed. In that case, the titanium dioxide concentration was adjusted to 5% by weight and the trimethoxypropylsilane concentration was adjusted to 10% by weight. Subsequently, bead mill treatment was performed for 480 minutes under the conditions of the number of rotations of a stirring shaft of 3485 rpm and a pump flow rate of 10 kg/h while applying supersonic vibration to the tank at a frequency of 35 kHz and an output of 100 W to thereby obtain a dispersion liquid. The evaluation results are shown in Table 7.

### Example 32

In a dispersion container of a bead mill having 400 g of zirconia beads having a particle size of 30 μm, nitrogen doped titanium dioxide powder (anatase) having a primary particle diameter of 15 nm, trimethoxypropylsilane, and 300 mL of diglyme were placed. In that case, the titanium dioxide concentration was adjusted to 10% by weight and the trimethoxypropylsilane concentration was adjusted to 20% by weight. Subsequently, bead mill treatment was performed for 1200 minutes under the conditions of the number of rotations of a stirring shaft of 3485 rpm and a pump flow rate of 10 kg/h while applying supersonic vibration to the tank at a frequency of 35 kHz and an output of 100 W to thereby obtain a dispersion liquid. The evaluation results are shown in Table 7.

TABLE 7

| | Ex. 28 | Ex. 29 | Ex. 30 | Ex. 31 | Ex. 32 |
|---|---|---|---|---|---|
| Transmittance | 96 | 93 | 82 | 86 | 87 |
| [%] | | | | | |
| Scattering | 0.63 | 0.94 | 2.7 | 2.5 | 2.4 |
| ratio [%] | | | | | |

### Example 33

In a dispersion container of a bead mill having 400 g of zirconia beads having a particle size of 30 μm, nitrogen doped titanium dioxide powder (anatase) having a primary particle diameter of 15 nm, trimethoxypropylsilane, and 300 mL of diglyme were placed. In that case, the titanium dioxide concentration was adjusted to 0.5% by weight and the trimethoxypropylsilane concentration was adjusted to 1% by weight. Subsequently, bead mill treatment was performed for 120 minutes under the conditions of the number of rotations of a stirring shaft of 3485 rpm and a pump flow rate of 10 kg/h while applying supersonic vibration to the tank at a frequency of 35 kHz and an output of 100 W to thereby obtain a dispersion liquid. The evaluation results are shown in Table 8.

### Example 34

In a dispersion container of a bead mill having 400 g of zirconia beads having a particle size of 30 μm, nitrogen doped titanium dioxide powder (anatase) having a primary particle diameter of 15 nm, trimethoxypropylsilane, and 300 mL of diglyme were placed. In that case, the titanium dioxide concentration was adjusted to 5% by weight and the trimethoxypropylsilane concentration was adjusted to 5% by weight. Subsequently, bead mill treatment was performed for 480 minutes under the conditions of the number of rotations of a stirring shaft of 3485 rpm and a pump flow rate of 10 kg/h while applying supersonic vibration to the tank at a frequency of 35 kHz and an output of 100 W to thereby obtain a dispersion liquid. The evaluation results are shown in Table 8.

### Example 35

In a dispersion container of a bead mill having 400 g of zirconia beads having a particle size of 30 μm, nitrogen doped titanium dioxide powder (anatase) having a primary particle diameter of 15 nm, trimethoxypropylsilane, and 300 mL of diglyme were placed. In that case, the titanium dioxide concentration was adjusted to 5% by weight and the trimethoxypropylsilane concentration was adjusted to 7.5% by weight. Subsequently, bead mill treatment was performed for 480 minutes under the conditions of the number of rotations of a stirring shaft of 3485 rpm and a pump flow rate of 10 kg/h while applying supersonic vibration to the tank at a frequency of 35 kHz and an output of 100 W to thereby obtain a dispersion liquid. The evaluation results are shown in Table 8.

### Example 36

A dispersion liquid was obtained in the same manner as in the method described in Example 4, except changing the nitrogen doped titanium dioxide powder (anatase) to nitrogen doped titanium dioxide powder (rutile). The evaluation results are shown in Table 8.

### Example 37

To the nitrogen doped titanium dioxide (anatase) dispersion liquid obtained in Example 4, PO modified neopentylglycol diacrylate and 1-hydroxy-cyclohexyl-phenyl-ketone were added, and then the diglyme in the dispersion liquid obtained in Example 1 was distilled off while reducing the pressure from the atmospheric pressure to 3 hPs in 8 hours using a rotary evaporator. The water bath temperature in that case was 45° C., and the distilled diglyme was removed out of the system as appropriate. In the obtained optical material, the titanium dioxide concentration was adjusted to 5% and the photopolymerization initiator was adjusted to 1.4%.

A spacer was disposed between two glass substrates facing each other, and then the optical material was casted to the center of the glass substrates. Thereafter, the material was developed while closely contacting the glass substrates, and was irradiated with ultraviolet rays (50 mW/cm, 2,200 seconds) to be cured. The thickness of the obtained film-shaped optical resin molded product was 50 μm.

### Example 38

To the nitrogen doped titanium dioxide (anatase) dispersion liquid obtained in Example 4, 3-(trimethoxysilyl)propyl-2-methylacrylate and 1-hydroxy-cyclohexyl-phenyl-ketone were added, and then the diglyme in the dispersion liquid obtained in Example 1 was distilled off while reducing the pressure from the atmospheric pressure to 3 hPs in 8 hours using a rotary evaporator. The water bath temperature in that case was 45° C., and the distilled diglyme was removed out of the system as appropriate. In the obtained optical material, the titanium dioxide concentration was adjusted to 5% and the photopolymerization initiator was adjusted to 1.4%.

A spacer was disposed between two glass substrates facing each other, and then the optical material was casted to the center of the glass substrates. Thereafter, the material was developed while closely contacting the glass substrates, and was irradiated with ultraviolet rays (50 mW/cm, 2,200 seconds) to be cured. The thickness of the obtained film-shaped optical resin molded product was 50 μm.

TABLE 8

| | Ex. 33 | Ex. 34 | Ex. 35 | Ex. 36 | Ex. 37 | Ex. 38 |
|---|---|---|---|---|---|---|
| Transmittance | 81 | 97 | 81 | 85 | 94 | 93 |
| [%] | | | | | | |
| Scattering | 2.8 | 0.53 | 2.9 | 2.5 | 0.83 | 0.90 |
| ratio [%] | | | | | | |

### Comparative Example 4

A dispersion liquid was obtained in the same manner as in the method described in Example 4, except changing the trimethoxypropylsilane to triethoxyhexylsilane. The evaluation results are shown in Table 9.

### Comparative Example 5

A dispersion liquid was obtained in the same manner as in the method described in Example 4, except changing the trimethoxypropylsilane to triethoxydodecylsilane. However, since the stability of the dispersion liquid was poor and the particles precipitated, the exact transmittance and the exact scattering ratio were not able to be measured.

### Comparative Example 6

A dispersion liquid was obtained in the same manner as in the method described in Example 4, except changing the trimethoxypropylsilane to methoxytrimethylsilane. However, since the stability of the dispersion liquid was poor and the particles precipitated, the exact transmittance and the exact scattering ratio were not able to be measured.

### Comparative Example 7

A dispersion liquid was obtained in the same manner as in the method described in Example 4, except changing the primary particle diameter of 15 nm to a primary particle diameter of 180 nm. The evaluation results are shown in Table 9.

### Comparative Example 8

A dispersion liquid was obtained in the same manner as in the method described in Example 4, except changing the diglyme to 2-propanol. The evaluation results are shown in Table 9.

### Comparative Example 9

A dispersion liquid was obtained in the same manner as in the method described in Example 4, except changing the nitrogen doped titanium dioxide powder (anatase) to titanium dioxide powder (anatase). However, since the stability of the dispersion liquid was poor and the particles precipitated, the exact transmittance and the exact scattering ratio were not able to be measured.

### Comparative Example 10

To the titanium dioxide (anatase) dispersion liquid obtained in Comparative Example 9, 3-(trimethoxysilyl)propyl-2-methylacrylate and 1-hydroxy-cyclohexyl-phenyl-ketone were added, and then the diglyme in the dispersion liquid obtained in Comparative Example 6 was distilled off while reducing the pressure from the atmospheric pressure to 3 hPs in 8 hours using a rotary evaporator. The water bath temperature in that case was 45° C., and the distilled diglyme was removed out of the system as appropriate. In the obtained optical material, the titanium dioxide concentration was adjusted to 5% and the photopolymerization initiator was adjusted to 1.4%.

A spacer was disposed between two glass substrates facing each other, and then the optical material was casted to the center of the glass substrates. Thereafter, the material was developed while closely contacting the glass substrates, and was irradiated with ultraviolet rays (50 mW/cm, 2,200 seconds) to be cured. The thickness of the obtained film-shaped optical resin molded product was 50 μm.

When the optical characteristics of the samples of Example 38 and Comparative Example 10 were evaluated, the refractive-index abnormal dispersion characteristic (θg, F value) of Example 39 was higher than that of Comparative Example 10 and an increase in θg and F value due to nitrogen doping was confirmed.

TABLE 9

| | Comp. | Comp. | Comp. | Comp. | Comp. | Comp. | Comp. |
|---|---|---|---|---|---|---|---|
| | Ex. 4 | Ex. 5 | Ex. 6 | Ex. 7 | Ex. 8 | Ex. 9 | Ex. 10 |
| Transmittance | 75 | — | — | 56 | 45 | — | 81 |
| [%] | | | | | | | |
| Scattering | 3.3 | — | — | 5.6 | 6.8 | — | 2.1 |
| ratio [%] | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-079564 filed Mar. 31, 2011, which is hereby incorporated by reference herein in its entirety.

What is claimed is:

1. A titanium dioxide dispersion liquid, comprising:
diglyme which is a solvent;
trimethoxypropylsilane which is a finishing agent; and
titanium dioxide fine particles having an average primary particle diameter of 1 nm or more and 30 nm or lower dispersed in a solution containing the diglyme and the trimethoxypropylsilane,
wherein
the transmittance of the titanium dioxide dispersion liquid is 80% or more.

2. A method for manufacturing an organic optical element, comprising:
mixing the titanium dioxide dispersion liquid according to claim 1 and an organic resin; and
volatilizing the solvent, and then curing.

3. A method for manufacturing a titanium dioxide dispersion liquid, comprising:
adding titanium dioxide fine particles having an average primary particle diameter of 1 nm or more and 30 nm or lower and containing an aggregate to a solution containing at least diglyme and trimethoxypropylsilane to produce a mixed solution; and then
performing dispersion treatment of the titanium dioxide fine particles of the mixed solution by an atomization device using beads having an average particle diameter of 15 μm or more and 30 μm or lower as a medium.

4. A method for manufacturing a titanium dioxide dispersion liquid, comprising:
adding titanium dioxide fine particles doped with nitrogen atoms, having an average primary particle diameter of 1 nm or more and 30 nm or lower, and containing an aggregate to a solution containing an organic dispersion medium and a silane compound represented by Formula (1) to produce a mixed solution; and then
performing dispersion treatment of the titanium dioxide fine particles of the mixed solution by an atomization device using beads having an average particle diameter of 15 μm or more and 30 μm or lower as a medium,
R¹R²ₙSi(OR³)₃₋ₙ Formula (1)
wherein, R¹ represents a C1 to C7 alkyl group, R² represents a C1 to C2 hydrocarbon group, R³ represents a C1 to C4 alkyl group, and n is 0 or 1.

5. A titanium dioxide dispersion liquid, comprising:
an organic dispersion medium;
a silane compound represented by Formula (1); and
titanium dioxide fine particles dispersed in a solution containing diglyme and trimethoxypropylsilane, doped with nitrogen atoms, having an average primary particle diameter of 1 nm or more and 30 nm or lower, and containing an aggregate,
wherein
the transmittance of the titanium dioxide dispersion liquid is 80% or more,
R¹R²ₙSi(OR³)₃₋ₙ Formula (1)
wherein, R¹ represents a C1 to C7 alkyl group, R² represents a C1 to C2 hydrocarbon group, R³ represents a C1 to C4 alkyl group, and n is 0 or 1.

6. The titanium dioxide dispersion liquid according to claim 4, wherein the organic dispersion medium is any one of 3-methoxy methyl propionate, diglyme, and methyl isobutyl ketone.

7. An organic optical element, comprising:
an organic resin containing a silane compound represented by Formula (I); and
titanium dioxide fine particles dispersed in the organic resin, doped with nitrogen atoms, having an average primary particle diameter of 1 nm or more and 30 nm or lower, and containing an aggregate,
R¹R²ₙSi(OR³)₃₋ₙ Formula (1)
wherein, R¹ represents a C1 to C7 alkyl group, R² represents a C1 to C2 hydrocarbon group, R³ represents a C1 to C4 alkyl group, and n is 0 or 1.
